(19) United States
(12) Patent Application Publication
(10) Pub. No.: US 2011/0290715 A1
(43) Pub. Date: Dec. 1, 2011

(54) FLUID FILTER AND FILTER SYSTEM

(76) Inventors: Andreas Mattern, Karlsruhe (DE); Tobias Hoeffken, Stuttgart (DE)

(21) Appl. No.: 12/998,893

(22) PCT Filed: Dec. 4, 2009
(86) PCT No.: PCT/EP2009/066424

§ 371 Date: Aug. 22, 2011

(30) Foreign Application Priority Data
Dec. 17, 2008 (DE) 102008054804.9
Mar. 6, 2009 (DE) 102009001383.3

(51) Int. Cl. C02F 1/00

(52) U.S. Cl. 210/500.1

(57) ABSTRACT

A fluid filter has a plurality of inlet channels, a plurality of outlet channels, and filter walls separating the inlet channels from the outlet channels. The inlet channels are parallel to the outlet channels, and the filter walls have a plurality of pores through which the inlet channels are connected to the outlet channels. A cross-sectional area of all inlet channels is larger than a cross-sectional area of all outlet channels, and a value of diameters of the pores of the filter walls calculated by mercury porosimetry being a median value d₅₀, being between 0.01 μm and 0.5 μm.

### BACKGROUND INFORMATION

The present invention relates to a fluid filter, in particular for filtering water, and a filter system having a fluid filter and a fluid.

Fluid filters are known from the related art in various embodiments. Membrane methods have recently been used to a growing extent, in particular in drinking water processing, and membranes based on polymers are being used in particular. However, such polymer membranes have the disadvantage that they have a relatively low strength. This results in a relatively frequent need for repairs of the membrane module in drinking water processing. Furthermore, to maintain a predetermined drinking water quality, the membranes must be cleaned regularly using aggressive chemicals. However, these chemicals attack the membranes and shorten the lifetime of the membranes. Acids, bases or chlorine-based oxidizing cleaning agents are often used for cleaning the membranes. Substantial knowledge is also required of an operating person here in order not to exceed a maximum allowed chlorine concentration.

### SUMMARY OF THE INVENTION

The fluid filter according to the present invention having the features of Patent Claim 1 has the advantage over the related art that it is designed to be very robust and resistant and is suitable for filtering water in particular. The fluid filter according to the present invention may be provided inexpensively. The fluid filter according to the present invention contains a plurality of inlet channels and a plurality of outlet channels, which are separated by filter walls between the inlet channels and the outlet channels. The inlet channels and outlet channels are situated parallel to one another, and the filter walls have a plurality of pores. The inlet channels are connected to the outlet channels via these pores. A cross-sectional area of all inlet channels here is larger than a cross-sectional area of all outlet channels. According to the present invention, the cross-sectional area of the inlet channels and outlet channels is understood to be an area ascertained perpendicular to the direction of flow of the channels. In addition, according to the present invention, a value ascertained by mercury porosimetry for the diameters of the pores of the filter walls is a median value d₅₀, median value d₅₀ for the diameter being between 0.01 and 0.5 μm, preferably 0.03 to 0.2 μm, particularly preferably between 0.05 and 0.15 μm. By using mercury porosimetry according to DIN 66133, for example, a value for a pore diameter and a pore diameter distribution may be ascertained using a standard measurement method. To describe the complex pore networks formed in sintering structures, it is customary to start with cylindrical model pores having a diameter according to the d₅₀ value.

Since a specific internal surface area is typically very difficult to ascertain experimentally in pores of the order of magnitude specified above, this may be approximated using the above model calculation using cylinder pores. Assuming cylindrical pores, the internal surface area of the pore structure is inversely proportional to the average pore diameter ascertained using the standard mercury porosimetry measurement method.

The subclaims describe preferred further refinements of the present invention.

Depending on the requirements of the filtration tasks, a filter medium adapted to these requirements is used according to the present invention, so that the lowest possible pressure drops occur during operation. To this end, the essential influencing parameters on the filter medium side (in particular pore size, porosity and wall thicknesses of the filter material) and on the fluid side of the fluid to be filtered (in particular the area-specific fluid volume flow (flux) and fluid viscosity and density) are taken into account in a special relationship to one another.

The filter material is characterized mainly by the internal surface area, which may be indicated by a function of the pore size, porosity and wall thickness. This presupposes that the pores are small enough to separate the substances to be separated and that their effect is considered only with respect to the pressure drop and not the separation behavior.

Thus the fluid filter according to the present invention is preferably characterized in that a flow resistance through the filter walls is defined as follows:

$$5 \times {10}^{2} [ N \text{/} {m}^{2} ] \leq 4.16 \frac{{( 1 - ɛ )}^{2}}{{ɛ}^{3}} μ {k}^{2} {Φ}^{- 2} vL + 0.292 \frac{( 1 - ɛ )}{{ɛ}^{3}} {ρ}_{f} k {Φ}^{- 1} {v}^{2} L \leq 1.5 \times {10}^{7} [ N \text{/} {m}^{2} ]$$

where:
ε=porosity
μ=dynamic fluid viscosity
k=proportionality factor between pore diameter and internal surface area
Φ=median d₅₀ of the pore diameter
ρ_{f}=fluid density
ν=specific volume flow (flux)
L=wall thickness of the filter layer, using a thickness of the finest filter layer because fluids are filtered according to the present invention

This takes into account a temperature range of 0° C.-60° C. and a flux range of 200-600 l/hm².

For determination of absolute values and comparison of filter wall materials which differ greatly (for example, woven fiber versus sintered structures), proportionality factor k must be determined experimentally, if necessary, or ascertained via models of the particular pore structure. For a relative comparison of similar pore structures (for example, in the case of sintered structures of extruded powders), it is admissible to assume that it is a constant 1.

Due to this design of flow resistance m of the filter wall, filtration optimally adapted to water may be achieved in particular. The values for the flow resistance are preferably between 2×10³ and 2×10⁵ N/m² in particular at a specific volume flow ν of 200 l/hm², a proportionality factor k=1 and a temperature range between 0° C. and 40° C. for one embodiment of the filter walls of a fine-pored substrate without a coating.

This equation is based on the Ergun equation, which indicates a flow resistance of a packing, but this equation has been modified accordingly by the present inventors for use with fluids. An equivalent pore diameter has been used as a substitute for a value of a specific internal surface area of the pores of the filter walls in particular. This equivalent pore diameter is inversely proportional to the internal surface area, assuming cylindrical pores, and is easily measurable by the standard measurement method of mercury porosimetry.

The fluid filter additionally preferably has a structure such that all the inlet channels and/or all the outlet channels are designed to be geometrically identical. This achieves a particularly uniform flow through the fluid filter.

To have the least possible flow losses, the inlet channels and/or the outlet channels are preferably designed in such a way that they have a hexagonal cross section. Only the outlet channels are preferably designed as equilateral hexagons. In this way, a particularly reduced flow loss is achieved. Alternatively, it is also possible for both the inlet channels and the outlet channels to be designed as equilateral hexagons.

In order to obtain the required stability for the fluid filter via the filter walls, the filter walls preferably have a porosity between 30% and 70%, preferably between 40% and 50%.

According to a preferred embodiment of the present invention, the filter walls include a base wall and an outer layer, which is situated on the side of the inlet channels. A pore size of the outer layer is smaller than a pore size of the base wall. The filtration performance is thus provided by the outer layer because the fluid flows first through the outer layer and then through the base wall. The base wall may be designed to have very large pores because it is responsible only for the mechanical strength of the fluid filter.

A thickness of the outer layer is preferably in a range from 10 μm to 200 μm, particularly preferably 20 μm to 80 μm. Furthermore, one or more additional layers are preferably also provided between the outer wall and the base wall. The pore size of these additional layers is between the pore size of the outer wall and the pore size of the base wall. This permits a design of the filter walls having a gradually increasing pore size, which has a positive influence on the flow performance through the filter wall in particular and simplifies manufacturability.

The filter wall is preferably made of a ceramic material in particular. Preferably Al₂O₃, ZrO₂, SiC, mullite, SiO₂, TiO₂, silicates or any combination of these materials is preferred as the material in particular. The filter wall may be manufactured completely from one ceramic material or a combination of these ceramic materials or only the outer wall is manufactured from these ceramic materials in the embodiment of the filter wall having one outer wall and one base wall. The base wall may be manufactured of a particularly inexpensive material.

Additionally preferably the surface of the filter wall is also provided with a coating which is preferably a material which permits an increase in hydrophilicity. For example, a coating using silanes may be provided here. In addition, a coating of the filter walls with a substance having an antibacterial effect is preferably provided. For example, the filter walls may be coated with Ag, AgO or TiO₂ to provide the antibacterial effect. Additionally preferably, the material for the filter wall or a coating is selected so that special surface charges are adjustable at certain pH levels. By adjusting the surface charge on the filter wall, selective deposition of certain components may be facilitated or the tendency toward deposition of certain impurities may be reduced. In this way, a longer cleaning interval for the fluid filter may be provided and/or cleaning of the fluid filter may be simplified.

Flow resistance m described above is preferably in a range of 5*10² to 5*10⁵ N/m² for one design of the filter walls made of a fine-pored substrate having a functional membrane coating, but only the geometric parameters of the functional layer, i.e., the most fine-pored layer, are used.

Furthermore, the present invention relates to a filter system having a fluid filter and a fluid to be filtered, in particular water. In the filter system the fluid to be filtered is passed through the fluid filter for filtering. The filter system is designed in particular for filtering water to produce drinking water or process water having similar purity requirements.

### BRIEF DESCRIPTION OF THE DRAWINGS

Preferred exemplary embodiments of the present invention are described below in detail with reference to the accompanying drawings.

FIG. 1 shows a schematic cross-sectional view of a fluid filter according to a first exemplary embodiment of the present invention;

FIG. 2 shows a schematic cross-sectional view of a fluid filter according to a second exemplary embodiment of the present invention; and

FIG. 3 shows an enlarged partial diagram of the fluid filter shown in FIG. 2.

### DETAILED DESCRIPTION OF THE INVENTION

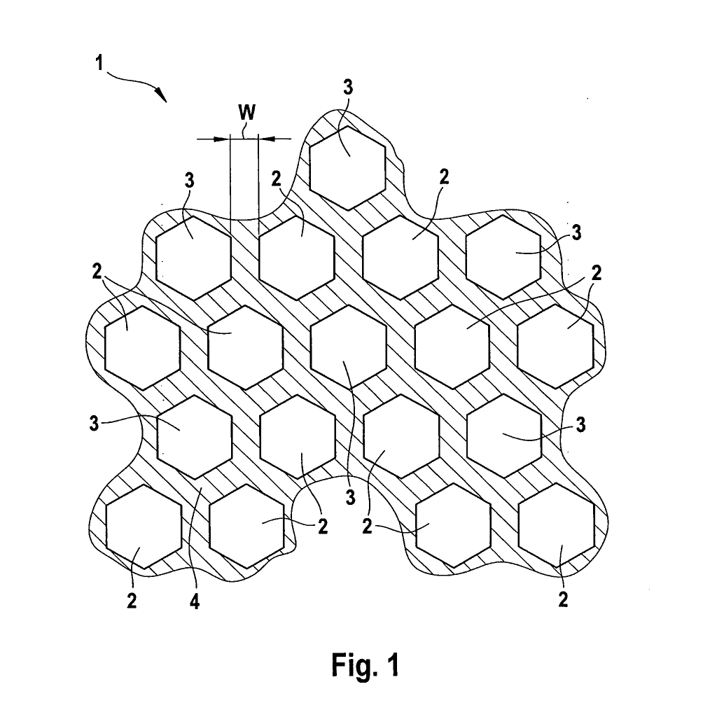

A fluid filter 1 according to a preferred exemplary embodiment of the present invention is described in detail below with reference to FIG. 1.

As FIG. 1 shows, only a partial detail of fluid filter 1 is shown in the cross-sectional view in FIG. 1. The total cross section of fluid filter 1 may be circular or square. As FIG. 1 shows, fluid filter 1 has a plurality of inlet channels 2 and a plurality of outlet channels 3. A filter wall 4 is provided between each of inlet channels 2 and outlet channels 3. Inlet channels 2 and outlet channels 3 are situated in parallel to one another, and thickness W of filter walls 4 is selected to be constant. Inlet channels 2 and outlet channel 3 each have the shape of an equilateral hexagon in cross section. The configuration of the hexagons in the fluid filter is such that the outside walls of inlet channels 2 are each parallel to the outside walls of outlet channels 3 (cf. FIG. 1). This yields a honeycomb structure of fluid filter 1.

In fluid filter 1 shown in FIG. 1, filter wall 4 thus functions as the filter element, the filter wall having a pore size in a range between 0.01 and 0.5 μm. The wall thickness of filter wall 4 is between 100 and 300 μm, and the porosity range of filter wall 4 is between 35% and 70%. The filter walls are designed to be homogeneous and thus have a pore size in the aforementioned range. The filter walls may be manufactured from a powder by a sintering method.

In this exemplary embodiment, the porosity of wall regions 4 is approximately 50%, a median value d₅₀ for a pore diameter being approximately 0.1 μm. Total wall thickness W between two parallel surfaces of the inlet channels and outlet channels is approximately 200 μm.

The total cross-sectional area of all inlet channels 2 is twice as great as the total cross-sectional area of outlet channels 3. A powder of a ceramic material, in particular Al₂O₃ or a silicate, is used as the powder for filter wall 4. It should be pointed out here that a very thin coating for an antibacterial effect is additionally provided using a nanoscale catalytic substance and/or a coating using a substance to increase hydrophilicity (for example, coating with silanes) may also be provided. Furthermore, the starting powder used to manufacture the filter walls may be chemically modified or mixed with additional materials to achieve special surface charges on the surface of filter walls 4.

Since the wall areas are completely manufactured of the same material, manufacturing may be performed very easily and inexpensively, for example, by extrusion of ceramic powder and subsequent sintering. It is also possible to ensure in this way that there is a homogeneous pore size distribution in filter walls 4. The outer shape of fluid filter 1 is preferably cylindrical, with inlet channels 2 being sealed at one axial end of the cylinder and outlet channels 3 being sealed at the other axial end of the cylinder. Thus if dirty water is supplied through inlet channels 2, it goes through filter walls 4 to outlet channels 3. Particles of dirt, etc., are then filtered out on the surface of filter walls 4 near the inlet channel. If the surface of inlet channels 2 becomes clogged after a certain period of time, these surfaces must be cleaned. This is achieved by reversing the direction of flushing by introducing water or a cleaning medium into outlet channels 3 for cleaning purposes, the water or cleaning medium then entering inlet channels 2 through filter walls 4 and then cleaning the surfaces of inlet channels 2. A cleaning operation of this type must be performed every 30 to 120 minutes, for example, for drinking water, for example, depending on the soiling of the water to be filtered.

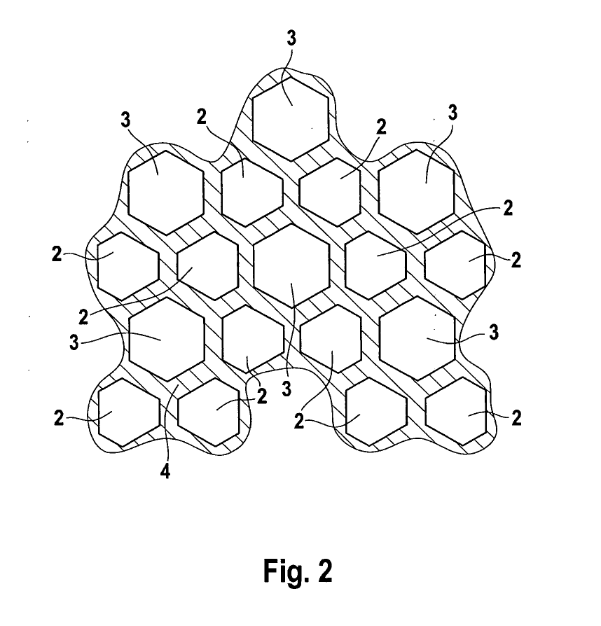

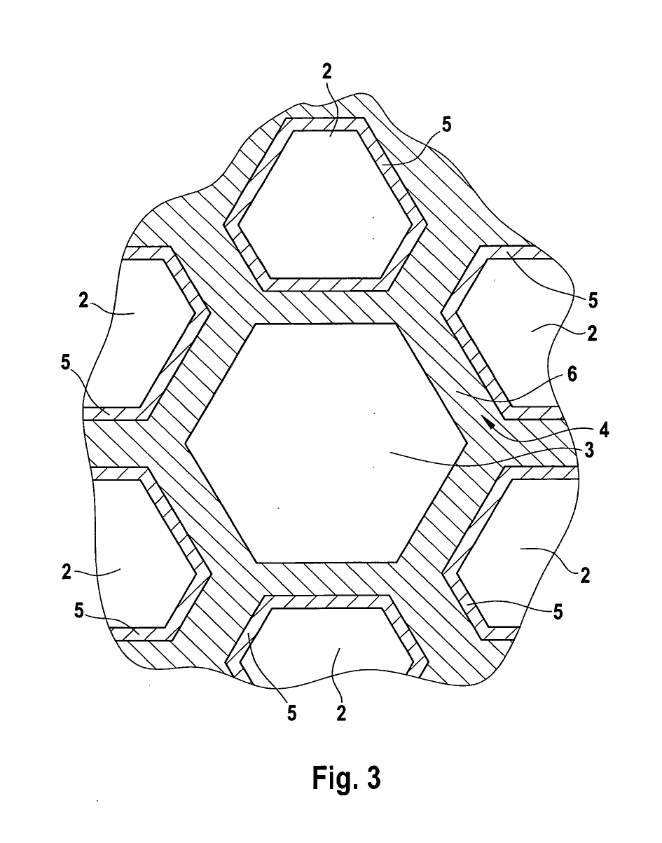

A fluid filter 1 according to a second exemplary embodiment of the present invention is described in detail below with reference to FIGS. 2 and 3. The same or functionally identical parts are labeled with the same reference numerals as in the first exemplary embodiment.

As shown in FIG. 2, outlet channels 3 in the second exemplary embodiment are designed as equilateral hexagons. In contrast with that, inlet channels 2 are not designed as equilateral hexagons. Inlet channels 2 are also hexagons but they have two pairs of sides, namely three longer sides and three shorter sides. The hexagons are formed here in such a way that a longer side and a shorter side are parallel to one another. In addition, in the exemplary embodiment the sums of the cross-sectional areas of all inlet channels 2 are 1.5 times greater than the sums of the cross-sectional areas of all outlet channels 3. The nonequilateral hexagons of inlet channels 2 are nevertheless symmetrical with a central axis. One side length of the longer side of the nonequilateral hexagons is of the same length as a side of the equilateral hexagons of outlet channels 3.

As also shown in FIG. 3, filter walls 4 have a different design from those in the first exemplary embodiment. According to the second exemplary embodiment, coatings 5 which are applied as a functional membrane layer to a base wall 6 are provided on the surfaces of inlet channels 2. Base wall 6 may be manufactured of a coarse-pored material having a low flow resistance and it functions as a carrier for coating 5, which has a fine-pored structure. The pore size of coating 5 is approximately 0.08 μm at a porosity of approximately 45%. The thickness of coating 5 is approximately 20 to 80 μm and is formed uniformly on each inlet channel 2. The wall thickness of base wall 6 is between 150 and 600 μm, preferably between 200 and 400 μm. Base wall 6 has a pore size greater than 1 μm.

Coating 5 may be manufactured, for example, by drawing a suspension through the fluid filter, so that the coating is then formed on the surface of inlet channels 2. Alternatively, the coating may be applied by a SOL/SOL method or a SOL/GEL method. In addition, another coating having an antibacterial effect and/or another coating to increase hydrophilicity may be provided. Likewise a coating to provide a special surface charge to the surfaces of inlet channels 2 may also be provided.

1-15. (canceled)

16. A fluid filter, comprising:
a plurality of inlet channels;
a plurality of outlet channels, wherein the inlet channels are situated in parallel to the outlet channels; and
filter walls separating the inlet channels from the outlet channels, wherein the filter walls have a plurality of pores through which the inlet channels are connected to the outlet channels;
wherein a cross-sectional area of all inlet channels is larger than a cross-sectional area of all outlet channels, and wherein a median value of diameters of the pores of the filter walls ascertained by mercury porosimetry is between 0.01 and 0.5 μm.

17. The fluid filter as recited in claim 16, wherein a flow resistance m through the filter walls conforms to the following relationship in a flux range of 200-600 l/(hm²), a temperature range between 0° C. and 60° C., and a proportionality factor k=1:
$$5 \times {10}^{2} N \text{/} {m}^{3} \leq 4.16 \frac{{( 1 - ɛ )}^{2}}{{ɛ}^{3}} μ {k}^{2} {Φ}^{- 2} vL + 0.292 \frac{( 1 - ɛ )}{{ɛ}^{3}} {ρ}_{f} k {Φ}^{- 1} {v}^{2} L \leq 1.5 \times {10}^{7} N \text{/} {m}^{2}$$
where:
ε=porosity
μ=dynamic fluid viscosity
k=proportionality factor between pore diameter and internal surface area
Φ=median value of pore diameter
ρ_{f}=fluid density
ν=specific volume flow or flux
L=wall thickness of filter layer.

18. The fluid filter as recited in claim 16, wherein at least one of (i) all inlet channels have an identical geometric shape, and (ii) all outlet channels have an identical geometric shape.

19. The fluid filter as recited in claim 18, wherein at least one of (i) the inlet channels are each formed as hexagons, and (ii) the outlet channels are each formed as hexagons.

20. The fluid filter as recited in claim 19, wherein at least one of (i) the inlet channels are each formed as equilateral hexagons, and (ii) the outlet channels are each formed as equilateral hexagons.

21. The fluid filter as recited in claim 17, wherein the filter walls have a porosity between 30% and 70%.

22. The fluid filter as recited in claim 18, wherein the filter walls have a base wall and an outer layer, the outer layer being situated on the side of the filter walls directed toward the inlet channels, and a size of the pores of the outer layer being smaller than a size of the pores of the base wall.

23. The fluid filter as recited in claim 22, wherein a thickness of the outer layer is between 10 μm and 200 μm.

24. The fluid filter as recited in claim 22, wherein at least one additional intermediate layer is situated between the outer layer and the base wall, and wherein a size of the pores of the at least one intermediate layer is between the size of the pores of the outer layer and the size of the pores of the base wall.

25. The fluid filter as recited in claim 22, wherein a surface area of the filter walls directed toward the inlet channels has at least one of a coating using silanes, an antibacterial coating, and a coating to determine surface charges.

26. The fluid filter as recited in claim 17, wherein the flow resistance m in the case of filter walls without a coating conforms to the following relationship at a constant flux of 200 l/(hm²), a temperature range between 0° C. and 40° C., and a proportionality factor k=1:
$$2 \times {10}^{3} N \text{/} {m}^{2} \leq 4.16 \frac{{( 1 - ɛ )}^{2}}{{ɛ}^{3}} μ {k}^{2} Φ vL + 0.292 \frac{( 1 - ɛ )}{{ɛ}^{3}} {ρ}_{f} k {Φ}^{- 1} {v}^{2} L \leq 2 \times {10}^{5} N \text{/} {m}^{2} .$$

27. The fluid filter as recited in claim 17, wherein the flow resistance m conforms to the following relationship in the case of filter walls having a functional membrane coating at a constant flux of 200 l/(hm²), a temperature range between 0° C. and 40° C., a proportionality factor k=1, and using the geometric properties of the layer having the finest pores:
$$5 \times {10}^{2} N \text{/} {m}^{2} \leq 4.16 \frac{{( 1 - ɛ )}^{2}}{{ɛ}^{3}} μ {k}^{2} {Φ}^{- 2} vL + 0.292 \frac{( 1 - ɛ )}{{ɛ}^{3}} {ρ}_{f} k {Φ}^{- 1} {v}^{2} L \leq 1.5 \times {10}^{5} N \text{/} {m}^{2} .$$

28. The fluid filter as recited in claim 17, wherein the filter walls are manufactured from ceramic material and contain at least one of Al₂O₃, ZrO₂, SiC, mullite, SiO₂, TiO₂, and silicates.

29. The fluid filter as recited in claim 17, wherein the fluid filter is configured to filter water to produce drinking water.
